(19) United States
(12) Patent Application Publication
(10) Pub. No.: US 2023/0206729 A1
(43) Pub. Date: Jun. 29, 2023

(54) NOVEL SYSTEM FOR GENERATING LEAGUE PROFILES WITHIN A NETWORK

(71) Applicant: Kavita RAMCHANDANI SNYDER, Capitola, CA (US)

(72) Inventor: Kavita RAMCHANDANI SNYDER, Capitola, CA (US)

(21) Appl. No.: 18/116,857

(22) Filed: Mar. 3, 2023

Related U.S. Application Data
(63) Continuation of application No. 17/891,117, filed on Aug. 18, 2022.
Application No. 17/891,117 is a continuation of application No. 17/567,875, filed on Jan. 3, 2022, now abandoned.
Application No. 17/567,875 is a continuation-in-part of application No. 16/037,891, filed on Jul. 17, 2018, now Pat. No. 11,216,786.

(51) Int. Cl. G07F 17/32; G06Q 50/34

(52) U.S. Cl. CPC G07F 17/3288; G06Q 50/34

(57) ABSTRACT

The present disclosure is directed to a system for generating league profiles within a network. The system includes a first set of computer servers programmed to store a plurality of user profiles and a plurality of sports clubs profiles. Each of the plurality of user profiles include at least one user attribute and each of the plurality of sports clubs profiles comprises identifier information associated with a spores club. Further, the system includes a second set of computer servers programmed to host a social media platform. The first set of computer servers are communicatively coupled to the second set of computer servers to publish information received from the first set of computer servers.

### CROSS-REFERENCE TO RELATED PATENTS

The present patent application claims priority to and is a continuation of Ser. No. 17/891,117 which was filed Aug. 18, 2022 which is a continuation of Ser. No. 17/567,875 filed Jan. 3, 2022 which is a continuation-in-part of U.S. non-provisional patent application Ser. No. 16/037,891 filed Jul. 17, 2018 in accordance with 35 U.S.C. 120.

### FIELD OF THE DISCLOSURE

The present disclosure is directed to a novel system for generating league profiles within a network.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an exemplary computer network of data processing systems in which illustrative embodiments may be implemented;

FIG. 2 is a block diagram of a data processing system in which illustrative embodiments may be implemented;

FIG. 3 is an exemplary illustration of a user profile with fields for attributes associated with an individual user within a network;

FIGS. 4-9 illustrate various computing systems according to one or more embodiments of the present disclosure;

FIG. 10 illustrates a user's calendar that has led on the league generation platform in accordance with one or more embodiments of the present disclosure;

FIG. 11A illustrates an exemplary betting interface for users to place bets on events and activities that originate or sponsored on the league generation platform; and

FIG. 11B illustrates an exemplary betting interface which can be generated by the league generation platform.

FIG. 12 illustrates an exemplary network of user amateurs which represent users in an online community.

### DETAILED DESCRIPTION

Before the present disclosure is described in detail, it is to be understood that, unless otherwise indicated, this disclosure is not limited to specific procedures or articles, whether described or not. It is further to be understood that the terminology used herein is for the purpose of describing particular embodiments only and is not intended to limit the scope of the present disclosure. It must be noted that as used herein and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

As will be appreciated by one skilled in the art, the present disclosure may be embodied as a system, method or computer program product. Accordingly, the present disclosure may take the form of an entirely hardware embodiment, a software embodiment (including firmware, resident software, micro-code, etc.) stored in a storage device, or an embodiment combining software and hardware aspects that may all generally be referred to herein as a “circuit,” “module,” or “system.” Furthermore, the present disclosure may take the form of a computer program product embodied in any storage device having computer readable program code embodied in the medium.

Any combination of one or more computer-readable storage device may be utilized. The computer-readable storage device may be, for example but not limited to, an electronic, magnetic, optical, electromagnetic, infrared, or semiconductor system, apparatus, or device. More specific examples (a non-exhaustive list) of the computer-readable storage device may include the following: a portable computer diskette, a hard disk, a random access memory (RAM), a read-only memory (ROM), an erasable programmable read-only memory (EPROM or flash memory), a portable compact disc read-only memory (CDROM), an optical storage device, or a magnetic storage device. processed in a suitable manner, if necessary, and then stored in a computer memory. In the context of this document, a computer-usable or computer-readable medium may be any medium that may contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

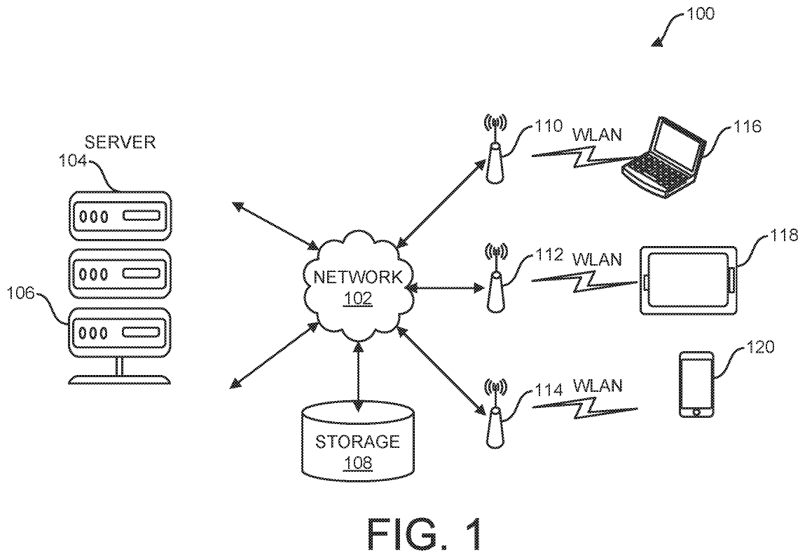

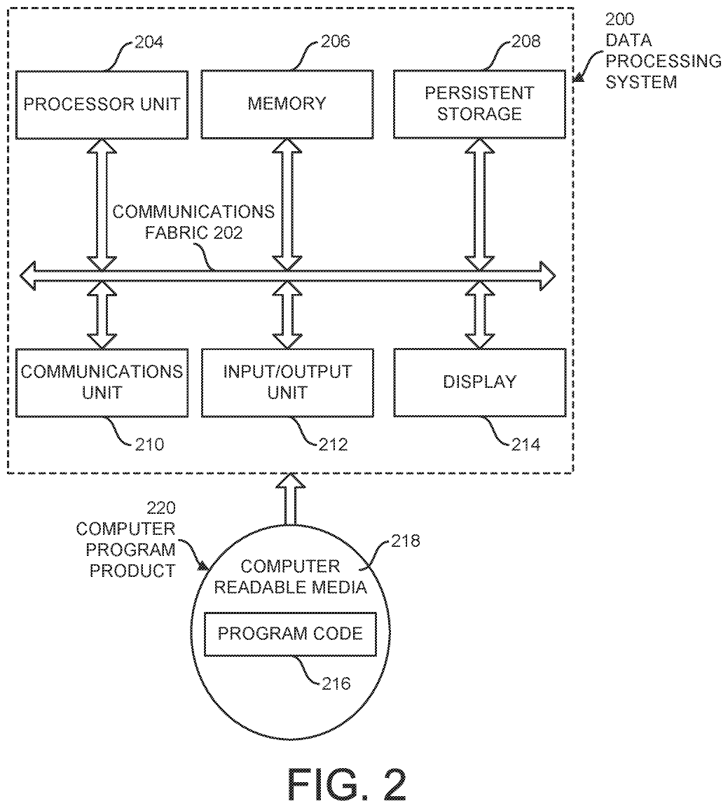

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to data processing environments in which different illustrative embodiments may be implemented. Many modifications to the depicted environments may be made.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

This specification includes references to “one embodiment” or “an embodiment.”

The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to”: perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. § 112, sixth paragraph, for that unit/component.

“First,” “Second,” etc. As used herein, these terms are used as labels for nouns that they precede, and do not imply any type of ordering (e.g., spatial, temporal, logical, etc.).

For example, reference to a “first” pre-defined distance does not necessarily imply that this pre-defined distance is the first pre-defined distance in a sequence; instead, the term “first” is used to differentiate this pre-defined distance from another pre-defined distance (e.g., a “second” pre-defined distance).

“League generation platform.” A software application hosted on a set of computer servers and ancillary devices and software systems known in the art.

“Competitive play.” Formal competitive events or activities in which scores are recorded, published, or shared to or by the league generation platform.

“Social play.” Informal competitive events or activities in which scores may not be recorded, published, or shared to or by the league generation platform.

Computer network system 100 is a network of data processing systems, such as, for example, computers and other devices, in which the illustrative embodiments may be implemented. One or more client devices employed within computer network system 100 may include a display screen, a plurality of microprocessors, and memory.

Computer network system 100 may include one or more networks which provide communication links between the various computers and other devices connected together within the computer network system 100. In some implementations, network 102 includes connections, such as wire(s), wireless communication links, fiber optic cables, etcetera.

In the example depicted in computer network system 100, servers 104, 106, and storage unit 108 are connected to network 102. Storage unit 108 may be capable of storing data in a structured or unstructured format. Additionally, storage unit 108 may represent a plurality of storage units coupled to network 102. In some implementations, storage unit 108 may, for example, include any database within an enterprise that stores and manages reusable software assets and any other data related to these reusable software assets. Access Points 110, 112, and 114 may function as a network device that allows client devices to connect to a wired network. However, the present disclosure is not limited thereto. In some implementations, an access point may connect to a router as a standalone device but may also be an integral component of the router itself in some implementations.

In addition, the access points 110, 112, 114 may provide wireless access to client devices 116, 118, 120. Client devices 116, 118, 120 may include personal computers, network computers, laptop computers, hand-held computers, personal digital assistants (PDAs), or smart cellular telephones (e.g., smartphones). It should also be understood by those having ordinary skill in the art that the client devices can be used to access, retrieve, and submit information to the league generation platform.

The league generation platform may be employed as a software application or software system. In one embodiment, the computer servers 104 includes a first set of computer servers and computer servers 106 include a second set of computer servers. The computer servers 104 may be programmed to store a plurality of user profiles.

In addition, computer servers 106 include are programmed to host a social media platform. In some embodiments, the first set of computer servers are communicatively coupled to the second set of computer servers to publish information received from the first set of computer servers.

In the embodiment shown, client device 116 is a laptop computer, client device 118 is a tablet, and client device 120 is a smartphone device. However, one having ordinary skill in the art should appreciate that the present disclosure is not limited to the specific network of client devices shown in FIG. 1.

In the implementation shown, access points 110, 112, and 114 are clients to server 104 and/or server 106. In addition, server 104 and/or server 106 may provide data, such as, for example, boot files, operating system images, and applications to access points 110, 112, and 114. Computer network system 100 may include additional servers, clients, and other devices not shown to implement processes of illustrative implementations.

Computer network system 100 may be implemented as a number of different types of networks, such as, for example, an intranet, a local area network (LAN), a wide area network (WAN), or the Internet. It should be noted that FIG. 1 is only intended as an example and not as an architectural limitation for the different illustrative implementations. For example, illustrative implementations may be implemented within a single data processing system or within a computer network system.

With reference now to FIG. 2, a block diagram of a data processing system is shown in which illustrative embodiments may be implemented. Data processing system 200 is an example of a computer, such as server 104 or client 120 in FIG. 1, in which computer-usable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display unit 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory (RAM) or any other suitable volatile or non-volatile storage device. Persistent storage 208 may take various forms depending on the particular implementation. For instance, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208. In addition, persistent storage 208 may represent a plurality of persistent storage units.

Communications unit 210, in these examples, provides for communications with other data processing systems or devices, such as, for example, server 104 in FIG. 1. In these examples, communications unit 210 is a network interface card. Communications unit 210 may provide communications through the use of either, or both, physical and wireless communications links.

Input/output unit 212 allows for input and output of data with other devices that may be connected to data processing system 200. For example, input/output unit 212 may provide a connection for user input through a keyboard. Display unit 214 provides a mechanism to display information to a user of data processing system 200.

Instructions for the operating system and applications or programs are located on persistent storage 208. The instructions for the operating system and applications or programs may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different illustrative embodiments may be embodied on different physical or tangible computer-readable media, such as memory 206 or persistent storage 208.

Program code 216 is located in a functional form on computer-readable media 218 and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive or a flash memory that is connected to data processing system 200. The tangible form of computer-readable media 218 is also referred to as computer-recordable storage media.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communication links or wireless transmissions containing the program code.

The different components illustrated for data processing system 200 are not meant to provide architectural limitations to the manner in which different illustrative embodiments may be implemented. The different illustrative embodiments may be implemented in a data processing system including components in addition to, or in place of, those illustrated for data processing system 200. Other components shown in FIG. 2 may be varied from the illustrative examples shown.

For example, a bus system may be used to implement communications fabric 202 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub, which may be present in communications fabric 202.

The present disclosure is directed to a system for generating league profiles within a network. The system includes a first set of computer servers programmed to store a plurality of user profiles and a plurality of sports clubs profiles. Each of the plurality of user profiles include at least one user attribute and each of the plurality of sports clubs profiles includes identifier information associated with a sports club. Further, the system includes a second set of computer servers programmed to host a social media platform. The first set of computer servers may be communicatively coupled to the second set of computer servers to publish information received from the first set of computer servers.

The present disclosure provides a manner of generating one or more customized league profiles which meet the attributes of a set of user profiles. The user profiles may be associated with members of a sports club, fitness club, social network, etcetera. In some embodiments, the user profiles may be stored in and retrieved from a computer database. Accordingly, user profiles may be ranked and then used to generate one or more league profiles which best reflect the attributes of users in a network (e.g., sports club, fitness club, social network, etc.). Once a league profile is generated, a system (e.g., software application) which employs the present disclosure may dispatch “intelligent invitations” to users within a network whose profiles best reflect the attributes associated with the generated league profile. The intelligent invitations may be any form of a message to the recipient for a request to join a league. For example, the intelligent invitations may be in a form of an email, text message, chat message, “in-app” message, or the like.

For example, the attributes associated with each user profile may be compared with the attributes associated with the generated league profile. In one embodiment, if a user profile has all of the attributes that are associated with the generated league profile, the user is sent a message requesting that the user join the league. In yet another embodiment, if a user's profile has greater than a threshold number of attributes associated with the generated league profile, the user is sent a message requesting to join the league.

In another embodiment of the present disclosure, a user that desires to create a league with the league generation platform may identify one or more users on the platform for which they would like to create a league of users with similar attributes. Accordingly, the league generation platform is configurable to enable the generation of league profiles automatically based on the commonality of user attributes on the platform.

Furthermore, the invitations may include details about the league (e.g., league type, roster schedule of games and practices, etc.). The invitations may be sent by any suitable means such as, but not limited to email, text message, chat message, in-app message, robo-call, etcetera. In response to receiving an invitation, a user may elect to join the league or simply decline. In some embodiments, a client device (e.g., smartphone) associated with a user may receive an invitation to join a league via a software application installed thereon.

In one embodiment of the present disclosure, users can partially accept, and thus partially reject, invitations to join a league. For example, if a user receives a request to join a tennis league for matches which occur on a specific day or over consecutive days, for a particular match style, and for a particular age group, the user can partially accept by indicating that they agree to join the league so long as the matches occur on a different day or set of days.

In another example, a user which receives an invitation to join a league may indicate in its response that it agrees to all of the attributes of the league but not the teammates that the user has been assigned to play with. In response to receiving a full acceptance, partial acceptance, partial rejection, or full rejections of the invitations, the league generation platform can confirm an employment of the league profile or generate a new league profile based on the users' responses to the invitations.

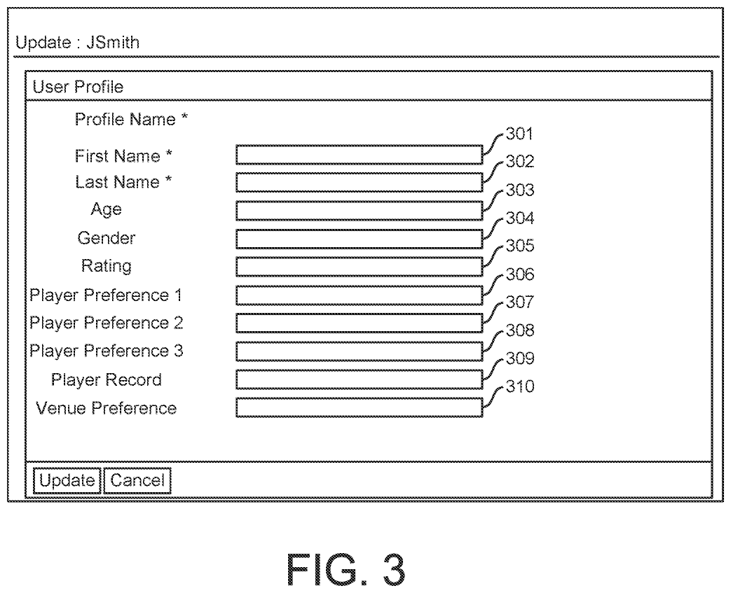

FIG. 3 is an exemplary illustration of a user profile 300 with fields for user attributes. As shown, the user profile 300 lists several attributes set out in various fields 301-310. Exemplary attributes may include a user's age, gender, first and last name, health profile, workout frequency, player rating, player ranking, and preference (e.g., teammates, game type, player position(s), player record, and venue preferences). It should be understood by those having ordinary skill in the art that the present disclosure is not limited to the attributes shown in FIG. 3. In some embodiments, some of the attributes associated with the user profiles may be excluded when generating league profiles. It should be understood by those having ordinary skill in the art that the user profiles do not need to have the same number or type of attribute fields.

The users on the league generation platform profiles may be members of various organizations (e.g., clubs, schools, recreational centers, neighborhoods, employers, fraternities/sororities or other social group, etcetera) which may have different fields. One or more league profiles may be generated despite the fact that a set of user profiles have different attribute types in their profiles. For example, the league generation platform described herein may be configured to create league profiles that place users that attend the same school, work for the same employer, etcetera to compete against users that attend a rival school or company.

Advantageously, the user profiles may be associated with individual profiles or team profiles. For example, if a user profile is a team profile and a threshold number of attributes are reflected by the team's profile, an invitation may be sent to each team member or a team's representative.

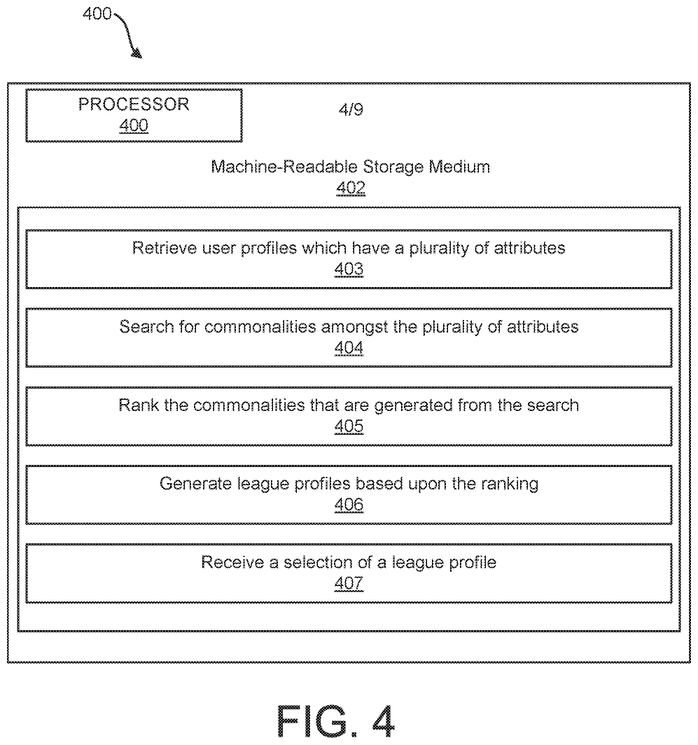

FIG. 4 illustrates computing systems according to one or more embodiments of the present disclosure. The computing system 400 includes a non-transitory computer readable medium 402 that includes computer executable instructions 403-407 stored thereon that, when executed by one or more processing units 401 (one processor shown), causes the one or more processing units 401 to serve as a league generation platform consistent with the present disclosure.

Computer readable medium 402 includes computer executable instructions 403 to retrieve user profiles. The user profiles may be retrieved from a database of information associated with members of one or more clubs (e.g., recreational clubs). The league generation platform may be configured such that specific user profile(s) are afforded greater weight than other user profiles. For example, user profiles of members of a recreational center may be weighted according to a membership classification. Furthermore, the league generation platform may be configured such that specific user attributes are afforded greater weight than other user attributes.

In one embodiment of the present disclosure, the user profiles retrieved are filtered such that only certain users associated with the user profiles are considered for constructing a league (or team). For example, the league generation platform may be configured to filter user profiles such that they only include users that are connected in some way. For example, each user profile may include a user's social media connections and the user profiles may be filtered, either before or after the league generation platform performs a search for commonalities.

Computer readable medium 402 also includes computer executable instructions 404 to search for commonalities amongst user profiles within a set (e.g., a database). For instance, a search may reveal that the greatest commonality among user profiles within a set are female members which prefer to play matches on Monday evenings from 6-8 pm PST.

Computer readable medium 402 also includes computer executable instructions 405 to rank the commonalities that are generated from the search. The commonalities may be ranked from greatest to least. Ranking the commonalities may include tallying the total number of attributes that each user has in common with other users within the set and then ranking the commonalities from greatest to least. In some embodiments, at least one of the highest ranked commonalities may be selected. Accordingly, the league generation platform can be used to rank and select user commonalities to create a league profile that is customized to the users represented in the set. In some implementations, artificial intelligence and machine learning may be used to search for commonalities within a set and search for attribute trends associated with the profiles of new users. For example, upon ranking the commonalities, it may be revealed that the greatest commonality amongst all users within the set is that the user profiles that the users are female whereas the least commonality among the users is that they have an amateur player rating.

Further, computer readable medium 402 includes computer executable instructions 406 to generate one or more league profiles based upon a previous ranking. The league profiles may be generated based on any of the ranked commonalities. For example, a league profile may be generated from a highest ranked commonality, a number of highest-ranked commonalities, etcetera.

Contrariwise, a league profile may be generated based on a median number of commonalities with the objective to create a league that accounts for many users within the set. Once the league profiles are generated, computer executable instructions 407 can enable the league generation platform to retrieve a selection of a league profile administrators, league organizers, or other authorized users on the platform.

A league profile may be chosen from one of the generated league profiles in various ways. One example method algorithm may be employed to automatically select one of the generated league profiles based upon pre-defined rules. For example, an algorithm may select one of the generated league profiles may be selected via a round-robin, weighted round-robin, random, manually, or other suitable methods.

Once a league profile is selected, one or more invitations may be dispatched to users whose profiles match the commonalities from which the selected league profile was created. For example, if the league profile was generated based on the user attributes of an experienced (player rating) female (gender) between the ages of 31 and 35 (age), the league generation platform may only send out invitations to users whose profiles reflect these attributes.

In addition, the league generation platform may be configured to send updates which joined the league. The updates may include messages regarding acceptances by the users or other users which were sent the invitations, declines, or other information pertinent to the league. For example, a user may receive an update that the league has been filled and that no other users may elect to join the league. Another example may involve a user receiving an update of the number of spots left to join the league.

In some embodiments of the present disclosure, the software application may generate one or more teams for the selected league profiles. For example, in response to a selected league profile, the league generation platform may automatically generate users for one or more teams for the selected league(s). As such, the communications sent to the users may include an invitation to play in a league on a certain team. The names of the other teammates (or proposed teammates) or other user attributes may be included in the communication. In the event that a user recipient of the communications declines the invitation to join the team, the user may be sent further communications to determine whether they want to join a league but on a different team. In the event that a user recipient of the communications declines the invitation to join the league all together, another user which has a profile that meets the criteria of the (generated or retrieved) league profile may be sent an invitation to join a team and the league.

In addition, the users may have filtering options on a companion software application on their client device to exclude receipt of certain types of invitations. For example, if a user is not interested in basketball, the user may elect to not receive invitations related to basketball. Furthermore, a user may elect via an option on a companion software application to only join a league or team if the users which have been sent invitations or have confirmed to join the league are members of the user's buddy list, contact list, social media connection or are within a certain degree of social media connections, age range, same gender, game location (or region), or peer rating. As such, the league generation platform allows users to be aware of and control the types of people that they will be involved with socially.

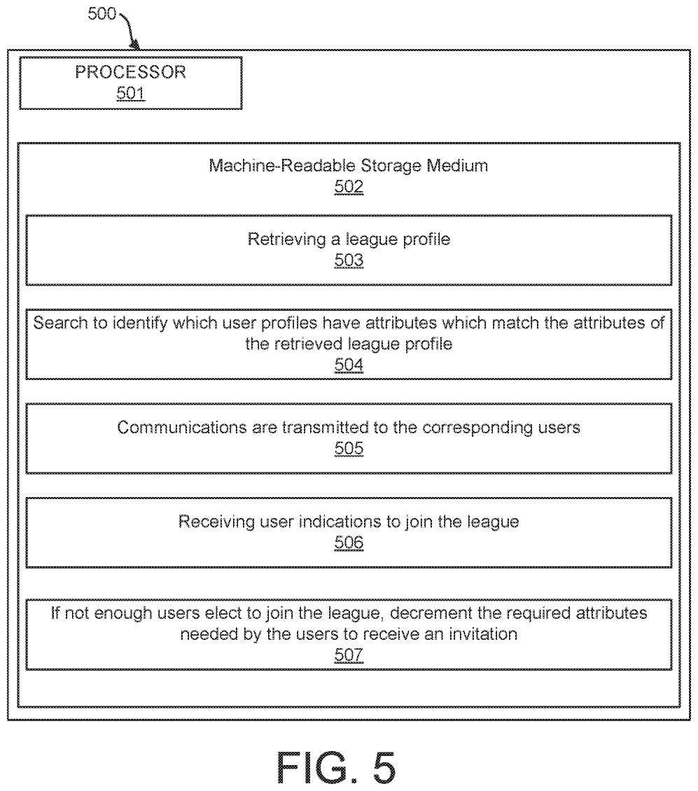

FIG. 5 illustrates computing systems according to one or more embodiments of the present disclosure. The computing system 500 includes a non-transitory computer readable medium 502 that includes computer executable instructions 503-508 stored thereon that, when executed by one or more processing units 501 (one processor shown), causes the one or more processing units 501 to serve as a league generation platform consistent with the present disclosure.

The league generation platform described in reference to FIG. 5 can generate and dispatch invitations to a plurality of users which meet the criteria of a pre-generated league profile. The league profiles may be retrieved from a computer database or any other suitable electronic storage device. For example, a league generation platform may store pre-configured default league profiles. A league organizer may select any of the pre-configured default league profiles according to the needs or objectives of the league organizer's organization. For example, a league organizer may select a league profile that is specifically tailored for an amateur league, a men's league, an over forty league, etcetera.

Advantageously, an administrator may select any one, or a combination of league profiles, and dispatch invitations to users on the league generation platform that have the attributes that are associated with the selected league profile. Therefore, the invitations are sent to users which best meet the attributes of the selected league profile.

Computer readable medium 502 includes computer executable instructions 503 to retrieve a league profile. In some embodiments, the league profile may include a hybrid of two or more league profiles in some embodiments of the present disclosure.

Hybrid league profiles may be created by various means such as, but not limited to, incorporating the user attributes associated with the highest commonalit(ies) from each of the selected league profiles. If these attributes from the selected league profiles for which the hybrid league profile leads to a sufficient number of users to fill the league, no further commonalities need to be considered. In some embodiments, if too many users are identified which meet the attributes of the hybrid league, additional attributes may be included based on other commonalities to limit the number of available users to join the league (or team).

Computer readable medium 502 includes computer executable instructions 504 to perform a search through the available user profiles to identify which user profiles have attributes that match the attributes of the selected league profile based on the users' profiles.

Computer readable medium 502 also includes computer executable instructions 505 to dispatch one or more invitations to the users which include the identified attributes in the users' profiles. The users, in turn, may accept or decline the invitations.

Computer readable medium 502 also includes computer executable instructions 506 to participate in the league by making an indication on their client device (e.g., smartphone). Additionally, computer readable medium 502 includes computer executable instructions 507 to retrieve the users' indications by a server which hosts the league generation platform according to one embodiment of the present disclosure. If not enough users accept the invitations to join the league (or team within the league), the platform may be used to send additional invitations to users whose profiles include attributes that do not directly match the attributes associated with the league profile. Meta data or tags to user attributes may be used to determine the degree of similarity between attributes.

Alternatively, if not enough users elect to join the league, the league generation platform employs computer executable instructions 508 may reduce the required attributes necessary to increase the available prospects to fill the league (or team within a league).

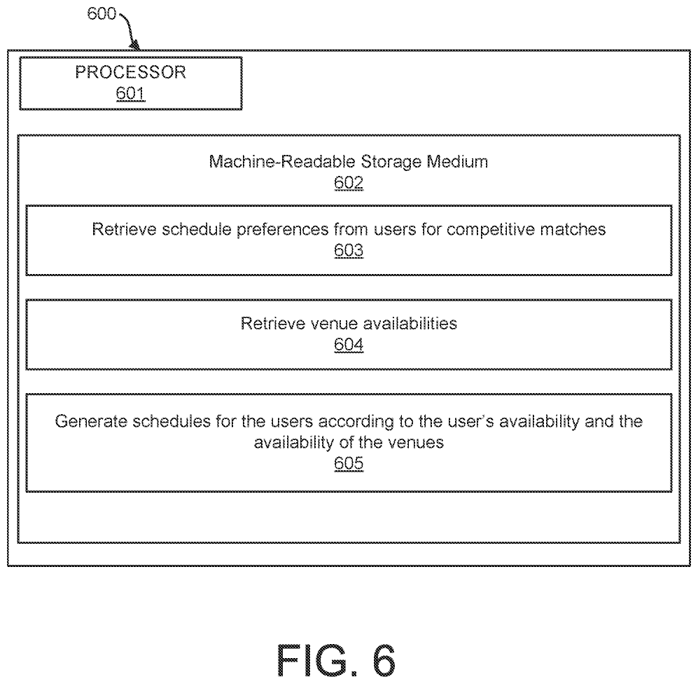

FIG. 6 illustrates computing systems according to one or more embodiments of the present disclosure. The computing system 600 includes a non-transitory computer readable medium 602 that includes computer executable instructions 603-605 stored thereon that, when executed by one or more processing units 601 (one processor shown), causes the one or more processing units 601 to serve as a league generation platform consistent with the present disclosure.

Computer readable medium 602 includes computer executable instructions 603 to, retrieve s11chedule preferences from user profiles for competitive matches. In addition, computer readable medium 602 also includes computer executable instructions 604 to retrieve venues availabilities. In one embodiment of the present disclosure, each venue is associated with a gym, sports franchise, recreational center, or private club. Accessing the availability of a plurality of venues may be accomplished by accessing one or more databases stored in a server or other electronic storage device.

Computer readable medium 602 includes computer executable instructions 605 to generate schedules for the users once the user profiles and venue availabilities are retrieved. Therefore, a league organizer can generate schedules for practices and matches without manual intervention from individuals or teams. Furthermore, weather information may be retrieved when generating the user schedules. In some implementations, the league generation platform can generate new schedules based on new weather information. For example, if the weather data received (or retrieved) indicates inclement weather conditions, the league generation platform may be configured to automatically generate new schedules which minimize the impact on practices or schedues matches.

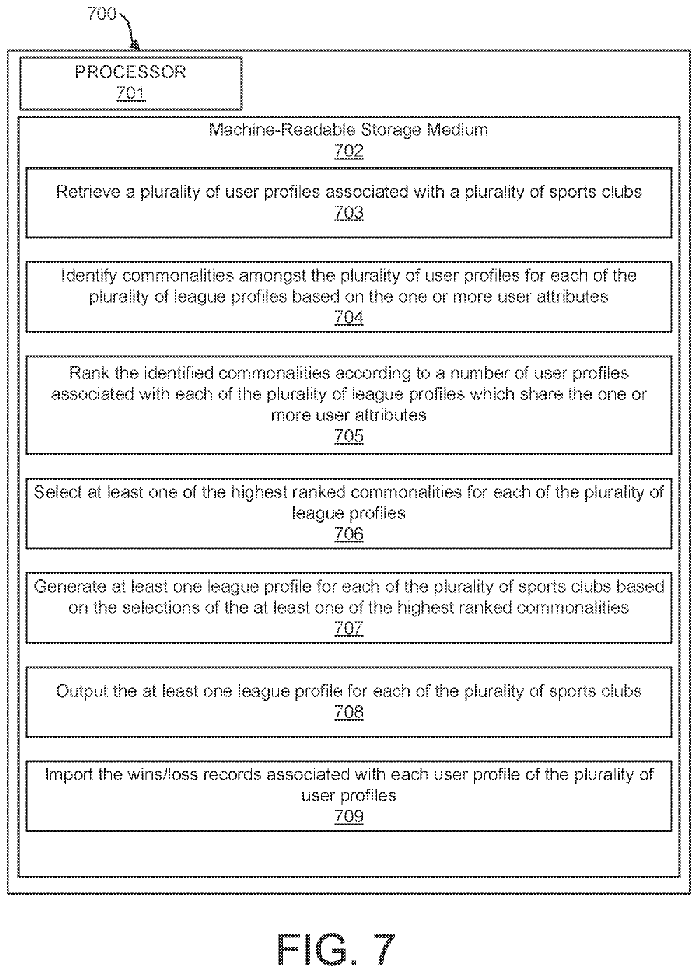

FIG. 7 illustrates computing systems according to one or more embodiments of the present disclosure. The computing system 700 includes a non-transitory computer readable medium 702 that includes computer executable instructions 703-709 stored thereon that, when executed by one or more processing units 701 (one processor shown), causes the one or more processing units 701 to serve as a league generator platform consistent with the present disclosure.

Computer readable medium 702 includes computer executable instructions 703 to retrieve a plurality of user profiles. The user profiles may be retrieved from a server (e.g., database server) with information associated with members of one or more clubs (e.g., recreational clubs).

In one embodiment of the present disclosure, the user profiles retrieved are filtered such that only certain users associated with the user profiles are considered for a league (or team). For example, the league generation platform may filter user profiles such that they only include users that are socially connected in some way. For example, each profile may include a user's social media profiles. The user profiles may be filtered either before or after the system performs a search for commonalities.

Further, computer readable medium 702 includes computer executable instructions 704 to retrieve a plurality of club profiles. In some embodiments, the plurality of club profiles are associated with at least one of the plurality of sports clubs.

Computer readable medium 702 also includes computer executable instructions 705 to identify commonalities amongst the plurality of user profiles based on the at least one user attribute. For example, identifying commonalties amongst the plurality of user profiles may reveal that many user profiles are female members which prefer to play matches on Monday evenings from 6-8 pm PST.

Furthermore, computer readable medium 702 includes computer executable instructions 706 to rank the commonalities, if any. The commonalities may be ranked from greatest to least. Ranking the commonalities may include tallying the total number of attributes that each user has in common with other users within the set and then ranking the commonalities from greatest to least. The league generation platform may be employed to select at least one of the highest ranked commonalities. Accordingly, a software application which employs the present disclosure may rank and select user commonalities to create a league profile that is customized to the users represented on the platform or for association (e.g., employee) or social group (e.g., fraternity). In some implementations, artificial intelligence and machine learning techniques may be used to search for commonalities within a set of user profiles and then search for attribute trends associated with the user profiles.

In addition, the league generation profile includes a computer readable medium 702 further includes computer executable instructions 707 to generate at least one league profile for each of the plurality of sports clubs based on ranking the identified commonalities. League profiles may be generated based on any of the ranked commonalities. For example, a league profile may be generated from a highest ranked commonality, a number of highest-ranked commonalities, etcetera.

Additionally, league profiles may be generated based on, at least in part, wins/loss records of the users within the system. In some implementations, a leaderboard or leader standing may be retrieved from a third-party source and implemented within a league generation platform described herein. It should be understood by those having ordinary skill in the art that a leaderboard has granular data such as gender, region rankings, etcetera. This data may be used to generate leagues. In other implementations, data associated with a third-party leaderboard may be stored in a server or other storage device which can be retrieved by a software application.

The leaderboard may include rankings and ratings of users and the league generation platform may incorporate this data when generating league profiles. The league generation platform can use rankings in the leaderboard to generate league profiles. For example, the platform may create teams such that there is league or team parity according to the users' ratings and rankings on the leaderboard.

Alternatively, a league profile may be generated based on a median number of attribute commonalities represented in the set with the objective to create a league that appeals to the most users on the league generation platform or for each association or social group. Computer readable medium 702 may also include computer executable instructions 708 to allow an administrator to select one or more generated league profiles to establish a league for their club, recreational center, etcetera.

A league profile may be chosen from one of the generated league profiles in various ways. In one implementation, a league profile may be automatically selected based upon pre-defined rules. For example, the league generation platform may select one of the generated league profiles via a round-robin, weighted round-robin, random, or other suitable methods. Further, computer readable medium 702 includes computer executable instructions 709 to dispatch one or more invitations to users within the network whose profiles include the attribute commonalities from which the selected league profile was created. For example, if the league profile was generated based on the user attributes of an experienced (player rating) female (gender) between the ages of 31 and 35 (age), the system will only send out invitations to users on the league generation platform whose profiles include these attributes.

Updates may be sent to the users which received the original invitations to join a league. The updates may include information regarding acceptances, declines by other users, or other information pertinent to the league. For example, a user may receive an update that a league has been filled and that no additional users can elect to join. In another example, a user can receive updates regarding the number of remaining spots or time period left to join a league.

In some embodiments of the present disclosure, the league generation platform described may automatically generate one or more teams for the selected league profiles. For example, in response to a selected league profile previously generated, the platform may automatically generate users for one or more teams for the selected league. As such, the invitations sent to the users may include an invitation to play in a league on a certain team. The names of the users pre-selected to join the team or users which have elected to join the team or other team information may also be included in the communication. In the event that a user declines an invitation to join the team, the user may be sent further messages to determine whether the user wants to join the league but on a different team. Furthermore, in the event that a user declines the invitation to join the league all together, another user which has a profile that meets the criteria of the (generated or retrieved) league profile may be sent an invitation to join a league if more users are needed to join the team.

In addition, the users may have filtering options on their companion software application which operates on their client device to exclude receipt of certain invitations. For example, if a user is not interested in joining a basketball league, the user may elect to not receive invitations about joining basketball leagues. Furthermore, a user may elect to only join a league or specific team of a league if the other users which have been sent or have already elected to join the league or team are members of a user's buddy list, contact list, social media connection or within a certain degree of separation of from the user's social media connections, age, gender, match, or peer ratings. In some embodiments, the invitations include a demographic profile of the users which have elected to join the league based on the demographics of the uses which have elected to join the team. Therefore, the league generation platform allows users to be aware of and determine the profiles of people that they will associate with recreationally.

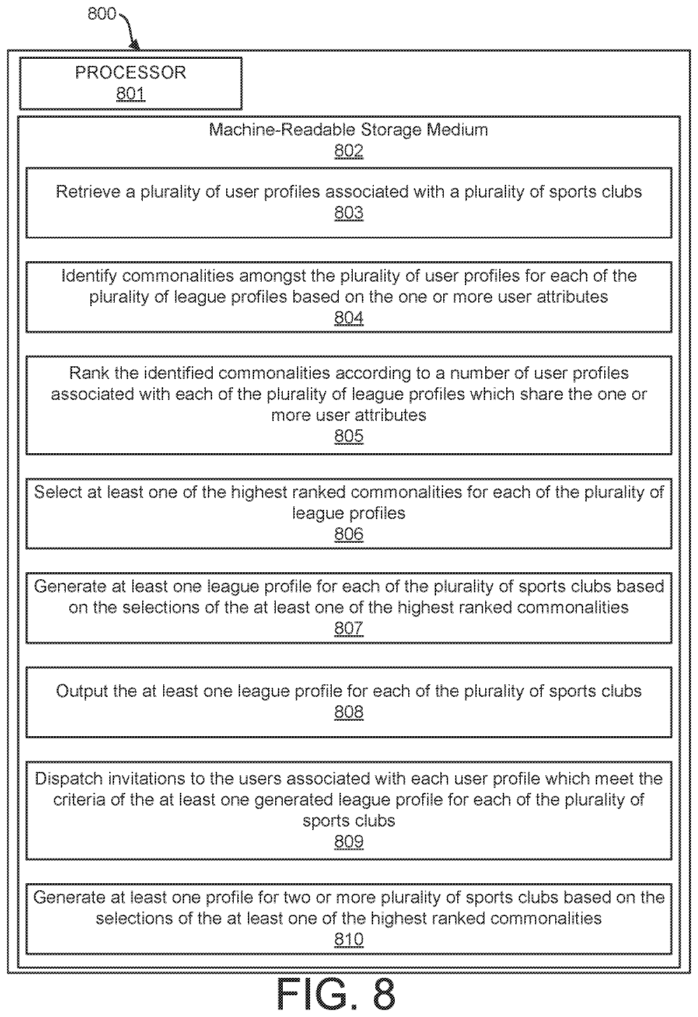

FIG. 8 illustrates computing systems according to one or more embodiments of the present disclosure. The computing system 800 includes a non-transitory computer readable medium 802 that includes computer executable instructions 803-814 stored thereon that, when executed by one or more processing units 801 (one processor shown), causes the one or more processing units 801 to serve as a league generator platform consistent with the present disclosure.

Computer readable medium 802 includes computer executable instructions 803 to retrieve a plurality of user profiles. The plurality of user profiles comprises at least one user attribute. Additionally, computer readable medium 802 includes computer executable instructions 804 to retrieve a plurality of sports clubs profiles. The plurality of sports clubs profiles may be associated with at least one of the plurality of sports clubs.

Further, computer readable medium 802 includes computer executable instructions 805 to identify commonalities amongst the plurality of user profiles based on the at least one user attribute. Further, computer readable medium 802 includes computer executable instructions 806 to rank the identified commonalities according to a number of the plurality of user profiles which include the at least one user attribute. Computer readable medium 802 also includes computer executable instructions 807 to generate at least one league profile for each of the plurality of sports clubs based on ranking the identified commonalities.

In addition, computer readable medium 802 also includes computer executable instructions 808 to dispatch invitations to the users associated with the plurality of user profiles which include the at least one user attribute that was the commonality used to generate the league profile. The invitations may be any one of an email, text message, or in-app message.

Additionally, computer readable medium 802 includes computer executable instructions 809 to finalize leagues associated with at least one of the plurality of league profiles based on a confirmation indication to join the leagues by the users which received the dispatched invitations. The league generation platform can also be configured to schedule matches for each of the finalized leagues (computer executable instructions 810).

Furthermore, computer readable medium 802 includes computer executable instructions 811 to generate a personal calendar for at least one user that confirmed to join a league. In some embodiments, the personal calendar reflects a schedule of events for the finalized league that the user joined.

The league generation platform can publish scores associated with each selected match according to computer executable instructions 811. Additionally, computer readable medium 802 includes computer executable instructions 812 to publish leader standings based on the published scores. In some embodiments of the present disclosure, the scores are published to a social media platform.

The league generation platform can record wins and losses for each scheduled match according to computer executable instructions 813. Advantageously, computer readable medium 802 includes computer executable instructions 814 to prompt users to place bets on player performance and matches associated with at least one of the finalized leagues.

The present disclosure may also be employed to enable user spectators follow players (e.g., users on the platform) and teams. A user spectator may be a user on the league generation platform which follows other users on the platform, events and activities, or teams. Notably, the league generation platform can send user spectators on the platform notifications of upcoming matches.

After a league generation platform generates a league, which may include a schedule of matches for the generated league, the platform may also post the schedule of matches. The schedule of matches may be associated with the players and/or teams assigned to those matches. Accordingly, the league generation platform described herein can generate league profiles, establish leagues, publish league match schedules, and allow user spectators on the platform to follow or receive updates and notifications associated with specific teams, players, and even venues. For example, user spectators may elect to receive notifications or specific players, teams, and venues.

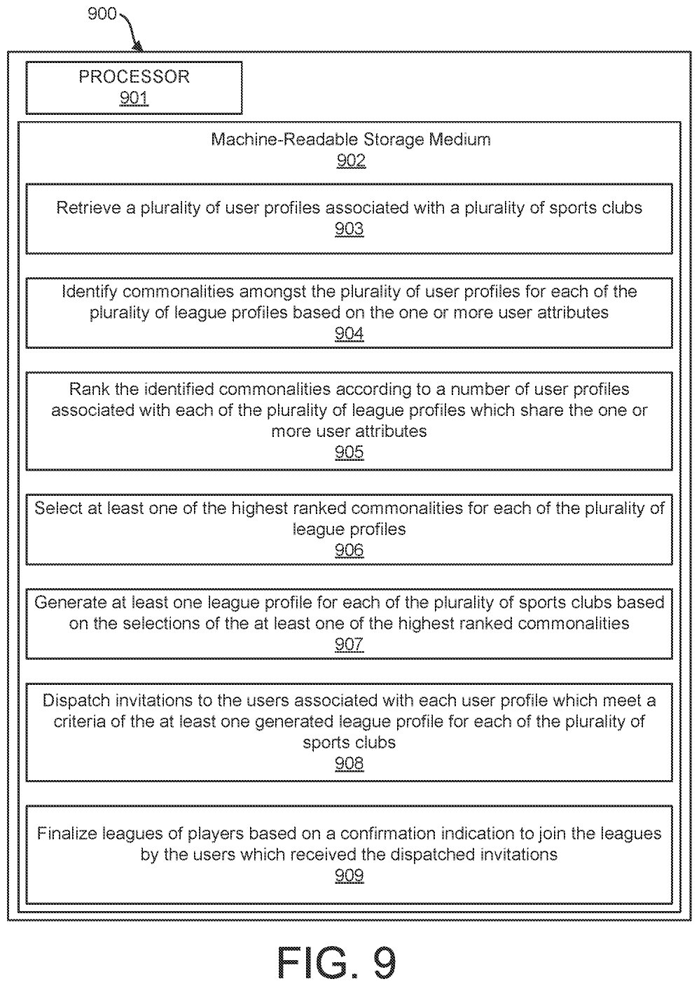

FIG. 9 illustrates computing systems according to one or more embodiments of the present disclosure. The computing system 900 includes a non-transitory computer readable medium 902 that includes computer executable instructions 903-909 stored thereon that, when executed by one or more processing units 901 (one processor shown), causes the one or more processing units 901 to serve as a league generator platform consistent with the present disclosure.

Computer readable medium 902 includes computer executable instructions 903 to retrieve a plurality of user profiles associated with a plurality of sports clubs. Computer readable medium 902 further includes computer executable instructions 904 to Identify commonalities amongst the plurality of user profiles for each of the plurality of league profiles based on the one or more user attributes; computer executable instructions 905 to rank the identified commonalities according to a number of user profiles associated with each of the plurality of league profiles which share the one or more user attributes; and computer executable instructions 906 to select at least one of the highest ranked commonalities for each of the plurality of league profiles.

Additionally, computer readable medium 902 includes computer executable instructions 903 to generate at least one league profile for each of the plurality of sports clubs based on the selections of the at least one of the highest ranked commonalities; and computer executable instructions 904 to dispatch invitations to the users associated with each user profile which meet a criteria of the at least one generated league profile for each of the plurality of sports clubs. Lastly, computer readable medium 902 includes computer executable instructions 903 to finalize leagues of players based on a confirmation indication to join the leagues by the users which received the dispatched invitations.

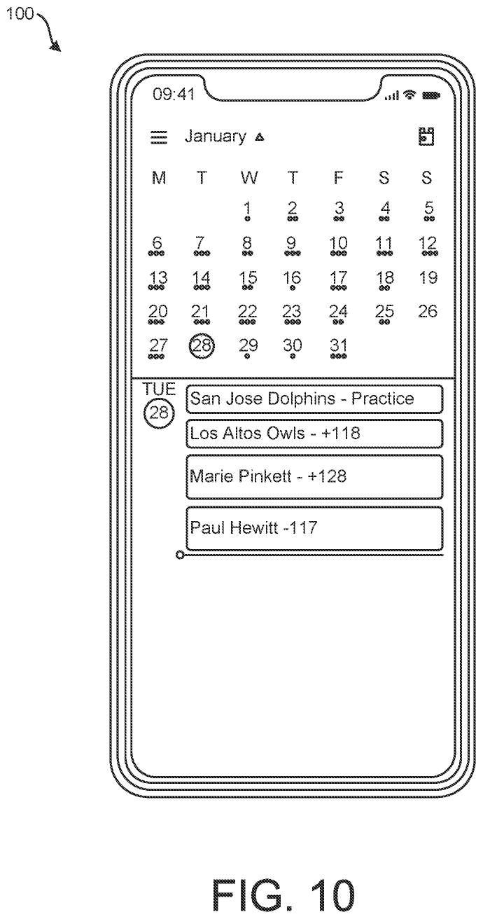

FIG. 10 illustrates a user's calendar that is hosted on the league generation platform in accordance with one or more embodiments of the present disclosure. Notably, calendar 1001 lists a schedule of events and activities hosted or promoted on the platform. The league generation platform may sync with its users' calendars. For example, upcoming events and activities associated with a user's profile may be retrieved, or sent to, a user's email client such that the user can view the scheduled events and activities on their personal calendars. In another example, user spectator events and activities (e.g., those which the user spectator agreed to follow and those which the user spectator will participate), can be synced with their personal calendars.

The league generation platform can generate and host calendars. The league generation platform may generate a calendar of events which hosts all events and activities that originate or are sponsored on the platform. Further, the league generation platform may also generate a plurality of calendars for users on its platform. The calendars associated with the users on the platform can display each user's events and activities associated with its team (practice and game schedules) and for events and activities associated with players, teams, and venues that the user follows. The league generation platform may be configured such that a plurality of calendars with dates and times of tentative matches and/or practices are pre-selected for each generated league profile. Furthermore, the user's calendar hosted on the league generation platform can include events and activities that the user has placed bets. As such, users on the league generation platform can use the calendars to aid in the decision process to join a league.

The league generation platform may be configured to require user spectators to pay a fee to attend events and activities which originated or are sponsored on the league generation platform. For competitive matches that are live streamed, for example, user spectators can purchase tickets to attend events virtually or in person.

In some embodiments, the league generation platform enables a payment mode for competitive play (e.g., competitive tennis matches) but disables payment mode for social play. Additionally, the league generation platform can be configured to publish league details (e.g., players, teams, match schedules, etc.). Users of the platform can therefore view league details and access information about various scheduled activities associated with players, teams, and venues on the platform. As such, after new events are published on the league generation platform, notifications can be automatically dispatched to users according to their settings informing them of the published events. The notifications may be sent as an in-app-message or any other suitable means known in the art.

For instance, a user subscriber on the league generation platform may have a friend on the platform that actively participates in competitive matches that originate on the platform. The user subscriber may configure their settings to receive notifications of all events, activities, updates, etc. associated with the friend. Therefore, if player highlights, match statistics, etcetera are published on the platform, the user will receive notifications thereof.

Furthermore, the league generation platform may be synced to users' social media accounts. Therefore, notifications of events and activities that originate from or are sponsored on the league generation platform may be shared to a user's social media account (e.g., Facebook, Twitter, Instagram, etc.). Accordingly, the league generation platform may be a central communications hub from where event and activity data originate but is shared to third-party platforms. Additionally, the league generation platform may be configured to enable users thereon to place bets on upcoming events, activities, etcetera. For example, users can place bets on player performance and competitive match outcomes.

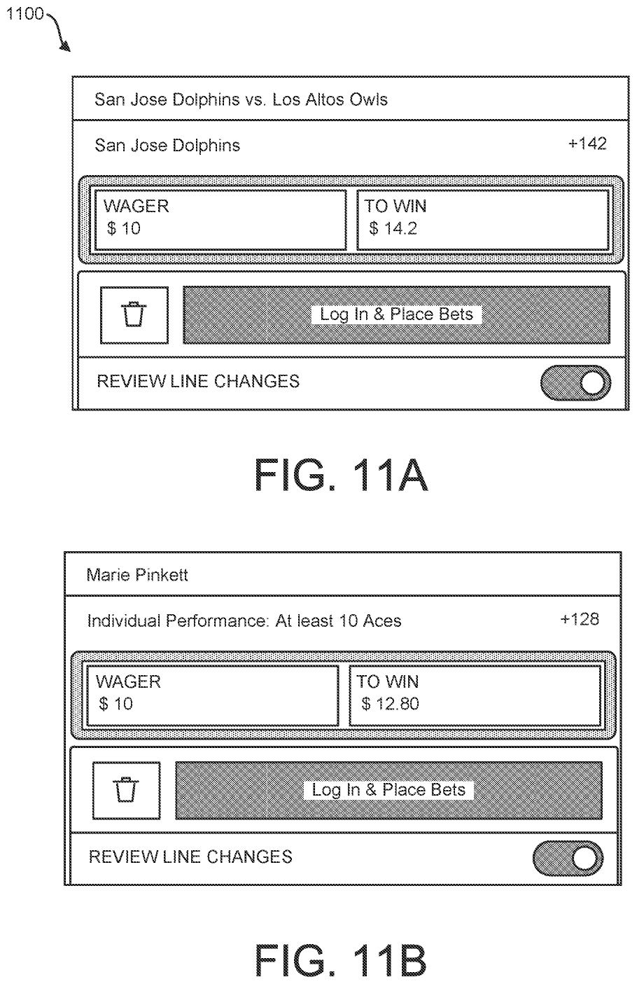

FIG. 11A illustrates an exemplary betting interface 1100 for users to place bets on events and activities that originated, sponsored, or promoted on the league generation platform. The betting interface 1100 displayed illustrates an example of a user's bet on an outcome of a game (i.e., San Jose Dolphins vs. Los Altos Owls) originated, sponsored, or promoted on the platform. As shown, a $10 wager could yield the user a $4.20 return. In addition, users may place bets based on the generation of league profiles regardless of whether a generated league profile is instituted in a league.

One or more league profiles may implemented into a fantasy sports league. In one embodiment, the results of players and/or teams for an actual real-life league may be used in the virtual leagues to determine scores in the fantasy sports leagues. Therefore, users on the league generation platform are not limited to profiles of real leagues for sports betting or fantasy play but can institute other league profiles generated on the platform which are more suitable for their activities.

FIG. 11B illustrates another exemplary betting interface 1200 which can be generated by the league generation platform as shown, a user can place a bet on a player's individual performance for an upcoming match. As such, the league generation platform can allow users to place bets on game segments, entire games, performance for specific aspects of the game, overall player preference, etcetera. In some embodiments, the betting functionality is configured for competitive play. However, the present disclosure is not limited thereto. Moreover, the league generation platform is configurable to allow unique sets of rules for each league so long as they conform to the general rules of the platform.

Additionally, a system which employs the present disclosure may be configurable to reschedule practices and competitive matches, in addition to generate proposals for league modifications (e.g., in the future) in response to significant changes to the collection of user profiles. For example, the system may have one or more league profiles that change based upon the attributes associated with the user profiles within the network. For instance, if a league profile has a first set of attributes (e.g., women over 35, single matches on Saturday at 10 am), the league profile may change to reflect the attributes of the users accounting for new the user sign-ups (e.g., female between 21-35, doubles, matches on Saturdays at 1 pm). Most notably, a system described herein may employ artificial intelligence and machine learning to account for trends, anomalies, etcetera.

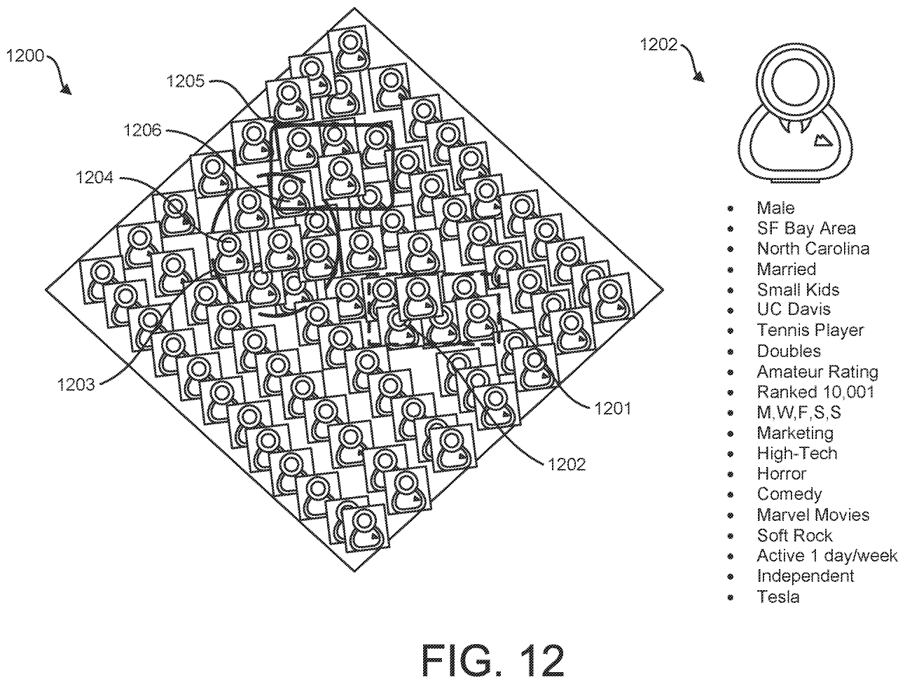

FIG. 12 illustrates an exemplary network 1200 of user amateurs which represent users in an online community. The user avatar 1207 represents an individual user in some embodiments and a team of individuals in other embodiments. Each user avatar 1207 may be therefore associated with an individual's user profile or a team's user profile. In the example shown, a list of attributes is associated with an individual's user profile. The attributes include the individual's user profile. The attributes include the individual user's gender, residence area (region), marital status, number of kids, colleges attended, sport of choice, game of choice, sports rating, ranking, days of the week available for practices and games, professional industry, favorite genre of books, least favorite genre of books, favorite movies, favorite music genre, level of weekly physical activity, and car manufacturer. One having ordinary skill in the art should appreciate that the present disclosure is not limited thereto.

Notably the users represented by the user avatars 1207 may be users connected on a social media network 1200 or any other online community so long as there are attributes associated with a plurality of the users. In some embodiments, a process (e.g., a software program is employed to determine attributes among the plurality of users on the online community. The process can generate a score which reflects how similar users are to the online community. Furthermore, the process can cluster users based on their profiles such that clusters of user profiles indicate similarity. Once the clusters are generated, advertisements, announcements, and other commonalities can be targeted to the cluster of users based on the commonalities of the cluster of user profiles. Sub-communities, organizations, leagues, etc., may be initiated to be formed automatically or manually initiated based on demographics of the online community. For example, users in the community which indicated that they reside in the SF Bay Area, enjoy Marvel movies, and are married may be invited out for a couple's outing to see a premier of a new Marvel movie. The process may have access to a list of popular events and activities which may be compared with the user attributes to determine the clusters among the users and for recommending group activities, events, and organizations. Any technique that employs a word similarity technique may be used to generate clusters and make recommendations.

FIG. 12 illustrates clusters 1201, 1203, 1205. However, not all users in the online community have to be in a cluster as shown in the figure. In the example, cluster 1201 has a plurality of users (e.g., avatar 1202), cluster 1203 also has a plurality of users (e.g., avatar 1204), and cluster 1205 has a plurality of users (e.g., avatar 1206). Notably, the user represented by avatar 1206 is in both cluster 1203 and 1205. As such, users may be in one or more clusters.

A novel system for generating league profiles has been described. It will be understood that the descriptions of some embodiments of the present disclosure do not limit the various alternative, modified, and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details. In other instances, well known methods, procedures, and components have not been described in detail so as not to unnecessarily obscure aspects of the present embodiments.

1. A computing device comprising at least one processor and a non-transitory computer readable medium storing computer readable instructions, when executed, causes a machine to:
retrieve a plurality of user profiles,
wherein each of the plurality of user profiles comprises at least one user attribute;
retrieve a plurality of sports clubs profiles,
wherein at least one of the plurality of sports clubs profiles are associated with at least one of the plurality of sports clubs;
identify commonalities amongst the plurality of user profiles based on the at least one user attribute;
rank the identified commonalities according to a number of the plurality of user profiles which include the at least one user attribute; and
generate at least one league profile for each of the plurality of clubs based on ranking the identified commonalities amongst the plurality of user profiles associated with the plurality of sports clubs.

2. The computing device of claim 1, further comprising computer readable instructions, when executed, causes a machine to select at least one of the highest ranked commonalities and generating the at least one league profile for each of the plurality of sports clubs based on the selections on the at least one of the highest ranked commonalities.

3. The computing device of claim it, wherein the plurality of sports clubs profiles include sports clubs' names and contact information.

4. The computing device of claim 1, wherein the at least one user attribute includes at least one of an age, gender, wins/loss record, contest availability, player ranking, player rating, employer, and contact information. The computing device of claim 4, further comprising computer readable instructions, when executed, causes a machine to import the wins/loss records associated with each of the plurality of user profiles and generate the at least one league profile based in part on the wins/loss record.

6. The computing device of claim 1, wherein each of the plurality of sports dubs is associated with at least one of a plurality of sports venue, sports club, and recreational center.

7. A computing device comprising at least one processor and a non-transitory computer readable medium storing computer readable instructions, when executed, causes a machine to:
retrieve a plurality of user profiles,
wherein each of the plurality of user profiles comprises at least one user attribute;
retrieve a plurality of sports dubs profiles,
wherein at least one of the plurality of sports clubs profiles are associated with at least one of the plurality of sports clubs;
identify commonalities amongst the plurality of user profiles based on the at least one user attribute;
rank the identified commonalities according to a number of the plurality of user profiles which include the at least one user attribute;
generate at least one league profile for each of the plurality of sports dubs based on ranking the identified commonalities amongst the plurality of user profiles associated with the plurality of sports clubs; and
dispatch invitations to users associated with the plurality of user profiles which include the at least one user attribute that was the commonality used to generate the league profile.

8. The computing device of claim 7, wherein the invitations are at least one of an email, text message, or in-app message,

9. The computing device of claim 7, further comprising computer readable instructions, when executed, causes a machine to finalize leagues associated with at least one of the plurality of league profiles based on a confirmation indication to join the leagues by the users which received the dispatched invitations.

10. The computing device of claim 9, further comprising computer readable instructions, when executed, causes a machine to schedule matches for each of the finalized leagues.

11. The computing device of claim 9, further comprising computer readable instructions, when executed, causes a machine to generate a personal calendar for at least one user that confirmed to join a league wherein the personal calendar reflects a schedule of events for the finalized league that the user joined.

12. The computing device of claim 7, further comprising computer readable instructions, when executed, causes a machine to publish scores associated with each scheduled match.

13. The computing device of claim 12, further comprising computer readable instructions, when executed, causes a machine to publish leader standings based on the published scores.

14. The computing device of claim 13, wherein the scores are published to a social media platform.

15. The computing device of claim 10, further comprising computer readable instructions, when executed, causes a machine to record wins and losses for each scheduled match.

16. The computing device of claim 10, further comprising computer readable instructions, when executed, causes a machine to prompt users to place bets on player performance and matches associated with at least one of the finalized leagues.

17. A system for generating league profiles, comprising;
a first set of computer servers programmed to store a plurality of user profiles and a plurality of sports clubs profiles,
wherein each of the plurality of user profiles comprises at least one user attribute and each of the plurality of sports clubs profiles comprises identifier information associated with a sports club; and
a second set of computer servers programmed to host a social media platform,
wherein the first set of computer servers are communicatively coupled to the second set of computer servers to publish information received from the first set of computer servers.

18. The system of claim 17, wherein the first set of computer servers are farther programmed to:
retrieve a plurality of user profiles,
wherein each of the plurality of user profiles comprises at least one user attribute;
retrieve a plurality of sports clubs profiles,
wherein at least one of the plurality of sports clubs profiles are associated with at least one of the plurality of sports clubs;
identify commonalities amongst the plurality of user profiles based on the at least one user attribute;
rank the identified commonalities according to a number of the plurality of user profiles which include the at least one user attribute; and
generate at least one league profile for each of the plurality of sports clubs based on ranking the identified commonalities amongst the plurality of user profiles associated with the plurality of sports clubs.

19. The system of claim 17, wherein the first set of computer servers are programmed to generate a personal calendar which reflects a schedule of events for the finalized league that the user joined the schedule of events to the second set of computer servers to publish on the social media platform.

20. The system of claim 17, wherein the first set of computer servers are programmed to publish scores and send the published scores to the second set of computer servers to be published.
